(19) United States
(12) Patent Application Publication
(10) Pub. No.: US 2026/0038890 A1
(43) Pub. Date: Feb. 5, 2026

(54) BATTERY PACK

(71) Applicant: LG ENERGY SOLUTION, LTD., Seoul (KR)

(72) Inventors: Min Bok LEE, Daejeon (KR); Ju Sung YI, Daejeon (KR); Chang Hyeon YANG, Daejeon (KR)

(73) Assignee: LG ENERGY SOLUTION, LTD., Seoul (KR)

(21) Appl. No.: 18/840,809

(22) PCT Filed: Feb. 16, 2023
(86) PCT No.: PCT/KR2023/002287

§ 371 Date: Mar. 13, 2025

(30) Foreign Application Priority Data
Feb. 23, 2022 (KR) 10-2022-0023960

(51) Int. Cl. H01M 10/42; H01M 10/48; H01M 50/284

(52) U.S. Cl. CPC H01M 10/425; H01M 10/482; H01M 10/486; H01M 50/284; H01M 2010/4271; H01M 2010/4278

(57) ABSTRACT

Discussed is a battery pack including a battery module, wherein the battery module includes: a cell stack in which a plurality of battery cells are stacked; a flexible circuit board configured to transmit information of at least one battery cell of the plurality of battery cells; a module housing configured to accommodate the cell stack and the flexible circuit board; a wireless transmission battery management system (BMS) configured to receive the information of the at least one battery cell from the flexible circuit board; and a BMS accommodation part provided outside the module housing to accommodate the wireless transmission BMS.

### CROSS-REFERENCE TO RELATED APPLICATION

The present application claims the benefit of the priority of Korean Patent Application No. 10-2022-0023960, filed on Feb. 23, 2022, which is hereby incorporated by reference in its entirety.

### TECHNICAL FIELD

The present invention relates to a battery pack.

### BACKGROUND ART

Secondary batteries are rechargeable unlike primarily batteries, and also, the possibility of compact size and high capacity is high. Thus, recently, many studies on secondary batteries are being carried out. As technology development and demands for mobile devices increase, the demands for secondary batteries as energy sources are rapidly increasing.

Rechargeable batteries are classified into coin type batteries, cylindrical type batteries, prismatic type batteries, and pouch type batteries according to a shape of a battery case. In such a secondary battery, an electrode assembly mounted in a battery case is a chargeable and dischargeable power generating device having a structure in which an electrode and a separator are stacked.

Secondary batteries are attracting much attention as energy sources for power devices such as electric bicycle, electric vehicles, and hybrid electric vehicles as well as mobile devices such as mobile phones, digital cameras, and laptops.

A small-sized battery pack in which one battery cell is packed is used for small devices such as mobile phones and cameras, but a battery pack in which two or more battery cells are connected in parallel and/or series is used for medium and large-sized devices such as laptop computers and electric vehicles. Thus, the number of battery cells provided in the battery pack may be variously set according to a required output voltage or charge/discharge capacity.

When the battery pack is configured by connecting a plurality of battery cells in series/parallel, a method in which a battery module constituted by at least one battery cell is configured first, and other components are added using the at least one battery module to constitute the battery pack is common.

That is, a battery is constituted by cells, which are the smallest units, and since a pouch-type cell requires structural rigidity, a module including a plurality of cells is provided as an intermediate unit, and then, a plurality of modules are provided to constitute a pack.

Since each of the modules in the pack has to be perform various signal sensing (voltage/temperature) through a battery management system (BMS), the modules are electrically connected to the BMS. In addition, the corresponding component is connected through a long wire called a low voltage (LV) line.

Recently, as the high voltage and high capacity of the pack progresses, the importance of stability within the pack is emerging, but when such an LV wire is provided in the pack, there is a problem of having a safety risk such as electrical short-circuit.

### DISCLOSURE OF THE INVENTION

### Technical Problem

One aspect of the present invention is to provide a battery pack capable of reducing an occurrence of a safety risk.

### Technical Solution

A battery pack according to an embodiment of the present invention may be a battery pack including a battery module, wherein the battery module may include: a cell stack in which a plurality of battery cells are stacked; a flexible circuit board configured to transmit information of at least one battery cell of the plurality of battery cells; a module housing configured to accommodate the cell stack and the flexible circuit board; a wireless transmission battery management system (BMS) configured to receive the information of the at least one battery cell from the flexible circuit board; and a BMS accommodation part provided outside the module housing to accommodate the wireless transmission BMS.

### Advantageous Effects

According to the present invention, in the battery pack, the battery module may include the wireless transmission BMS that receives the information of the battery cell disposed therein and the BMS accommodation part in which the wireless transmission BMS is accommodated so that the information of the battery cell is wirelessly transmitted. As a result, the wire such as the low voltage (LV) that connects the BMS inside the battery pack may not be used to reduce the occurrence of the safety risk. That is, the bundle of the wires such as the LV connecting the BMS may be removed to prevent the risk of the short circuit caused by applying the current and voltage to the bundle of the wires such as the LV.

In addition, since the BMS accommodation part is coupled to the outside of the module housing by the coupling means, the modularization may be easy, and the accessibility and repair in the event of the breakdown of the wireless transmission BMS accommodated in the BMS accommodation part may be facilitated.

The BMS accommodation part may be mounted on the endplate of the module housing and be mounted in the mounting groove recessed from the endplate toward the surplus internal space of the module housing to minimize the wasted space inside the battery module.

### BRIEF DESCRIPTION OF THE DRAWINGS

FIG. 1 is a projected plan view illustrating an example of a battery pack according to an embodiment of the present invention.

FIG. 2 is a perspective view illustrating a battery module in the battery pack according to an embodiment of the present invention.

FIG. 3 is an exploded perspective view illustrating the battery module in the battery pack according to an embodiment of the present invention.

FIG. 4 is a perspective view illustrating a cell stack in the battery module of the battery pack according to an embodiment of the present invention.

FIG. 5 is a side view illustrating a battery cell in the battery module of the battery pack according to an embodiment of the present invention.

FIG. 6 is a side view illustrating a main part of the battery cell in the battery module of the battery pack according to an embodiment of the present invention.

FIG. 7 is a perspective view illustrating a main part of the battery module in the battery pack according to an embodiment of the present invention.

FIG. 8 is an exploded perspective view illustrating the main part of the battery module in the battery pack according to an embodiment of the present invention.

FIG. 9 is a perspective view illustrating a concept in which an endplate is removed from the battery module of the battery pack according to an embodiment of the present invention.

FIG. 10 is a side view illustrating the main part of the battery module in the battery pack according to an embodiment of the present invention.

FIG. 11 is a side view illustrating the main part of the battery module in the battery pack according to an embodiment of the present invention.

### MODE FOR CARRYING OUT THE INVENTION

The objectives, specific advantages, and novel features of the present invention will become more apparent from the following detailed description taken in conjunction with the accompanying drawings. It should be noted that the reference numerals are added to the components of the drawings in the present specification with the same numerals as possible, even if they are illustrated in other drawings. Also, the present invention may be embodied in different forms and should not be construed as limited to the embodiments set forth herein. In the following description of the present invention, the detailed descriptions of related arts which may unnecessarily obscure the gist of the present invention will be omitted.

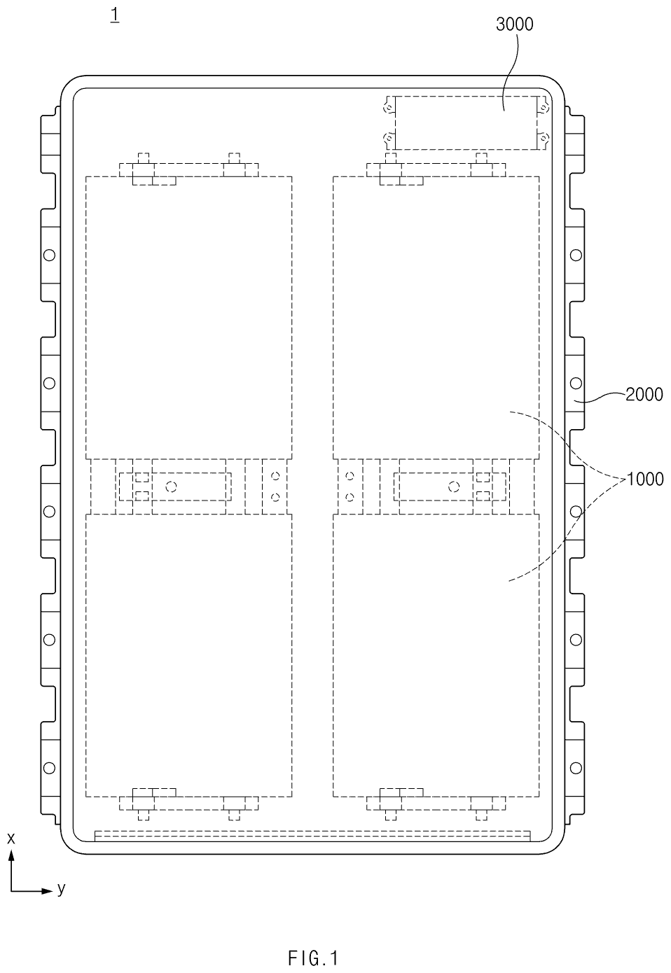

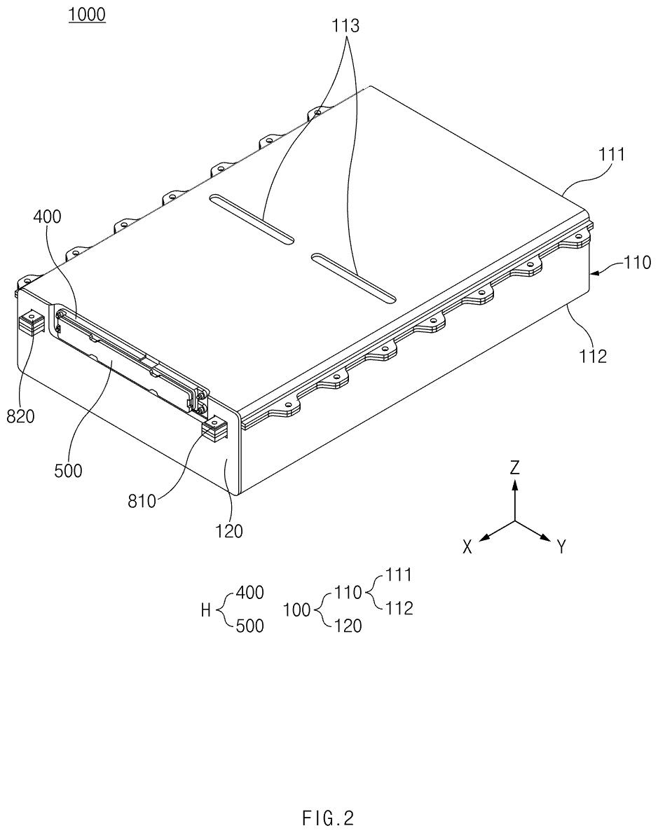

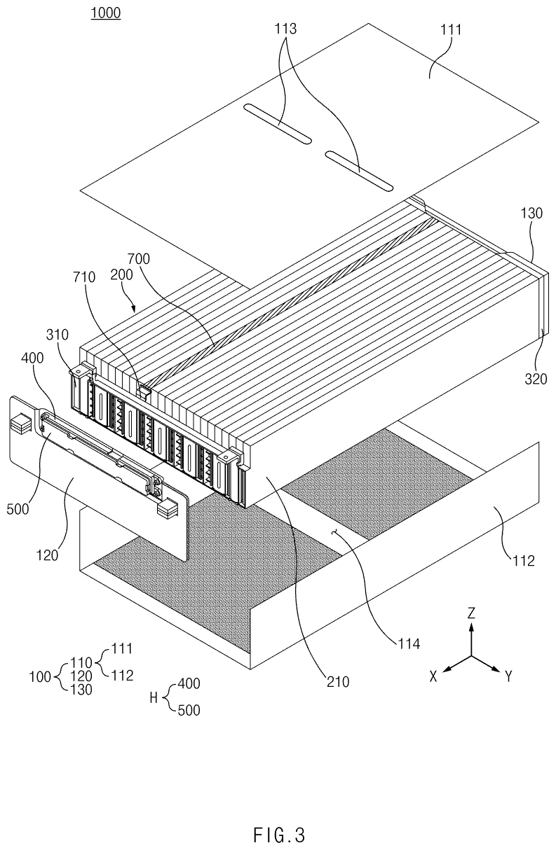

FIG. 1 is a projected plan view illustrating an example of a battery pack according to an embodiment of the present invention, FIG. 2 is a perspective view illustrating a battery module in the battery pack according to an embodiment of the present invention, and FIG. 3 is an exploded perspective view illustrating the battery module in the battery pack according to an embodiment of the present invention.

Referring to FIGS. 1 to 3, a battery pack 1 according to an embodiment of the present invention is a battery pack 1 including a battery module 1000, and the battery module 1000 includes a cell stack 200 in which a plurality of battery cells 210 are stacked, a flexible circuit board 700 that transmits information of the plurality of battery cells 210, a module housing 100 accommodating the cell stack 200 and the flexible circuit board 700, a wireless transmission BMS 600 receiving the information of the battery cell 210 from the flexible circuit board 700, and a BMS accommodation part H in which the wireless transmission BMS 600 is accommodated. In addition, the battery pack 1 according to an embodiment of the present invention may further include a wireless receiving BMS 3000 and a pack case 2000.

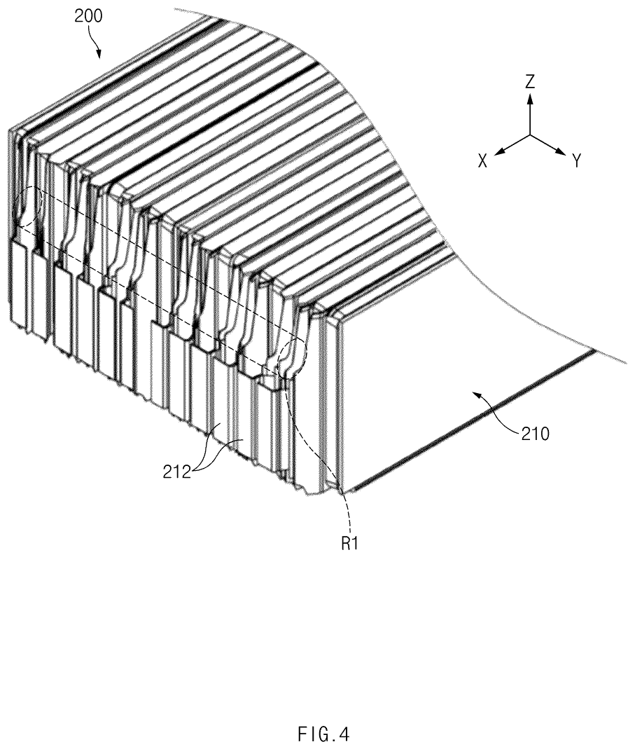

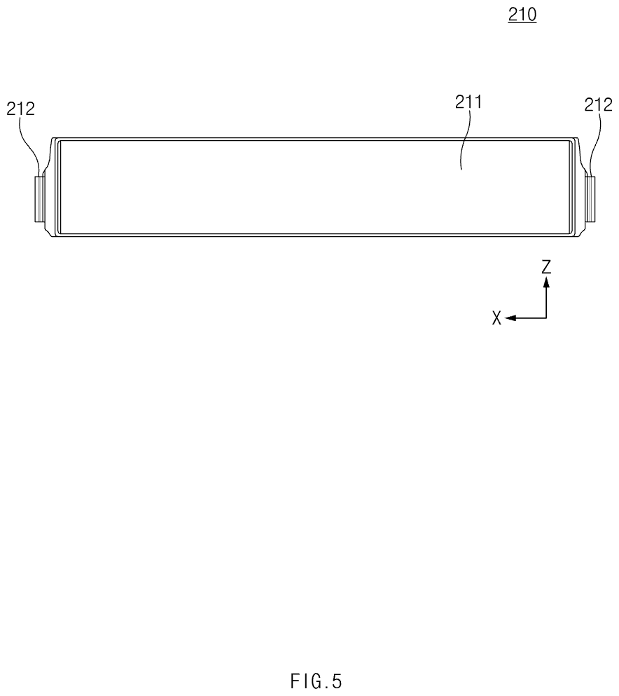

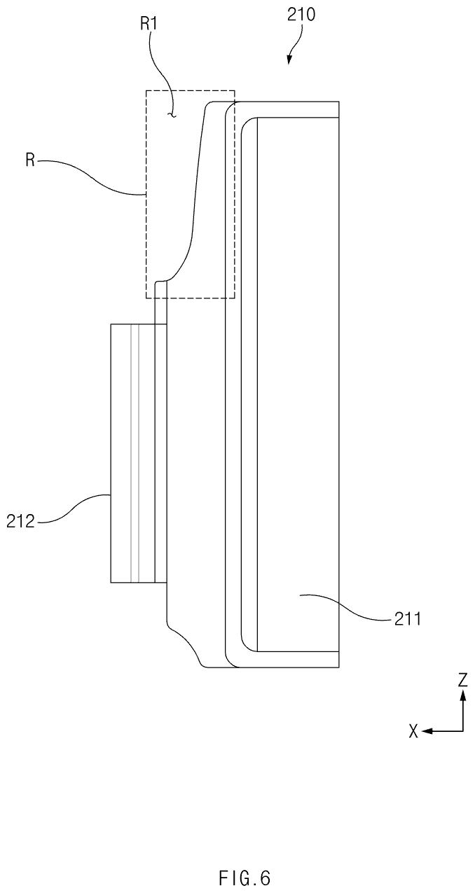

FIG. 4 is a perspective view illustrating the cell stack in the battery module of the battery pack according to an embodiment of the present invention, FIG. 5 is a side view illustrating the battery cell 210 in the battery module of the battery pack according to an embodiment of the present invention, and FIG. 6 is a side view illustrating a main part of the battery cell in the battery module of the battery pack according to an embodiment of the present invention.

In more detail, referring to FIGS. 4 to 6, the cell stack 200 may have a shape in which the plurality of battery cells 210 are stacked.

The battery cell 210 may include an electrode assembly and a pouch 211 accommodating the electrode assembly therein.

The electrode assembly may be a chargeable and dischargeable power generating element, and electrodes and separators may be alternately stacked in the electrode assembly. Here, the electrodes may include a positive electrode and a negative electrode, and the positive electrode, the separators, and the negative electrode may be alternately stacked. here, each of the separators separates the positive electrode from the negative electrode to electrically insulate the positive electrode from the negative electrode.

The battery cell 210 may further include an electrode lead 212 having one side connected to the electrode of the electrode assembly and the other side extending to the outside of the pouch 211.

In the battery cell 210, for example, the electrode lead 212 may extend to both sides. In addition, referring to FIGS. 5 and 6, as the electrode lead 212 is disposed to extend downward, a surplus space R1 that is an empty space may be defined in an upper edge portion R of the battery cell 210. Thus, referring to FIG. 4, when the plurality of battery cells 210 are stacked in a Y-axis direction that is a traverse direction to form the cell stack 200, a surplus space R1 that is an empty space may be defined in an upper edge portion R of the cell stack 200.

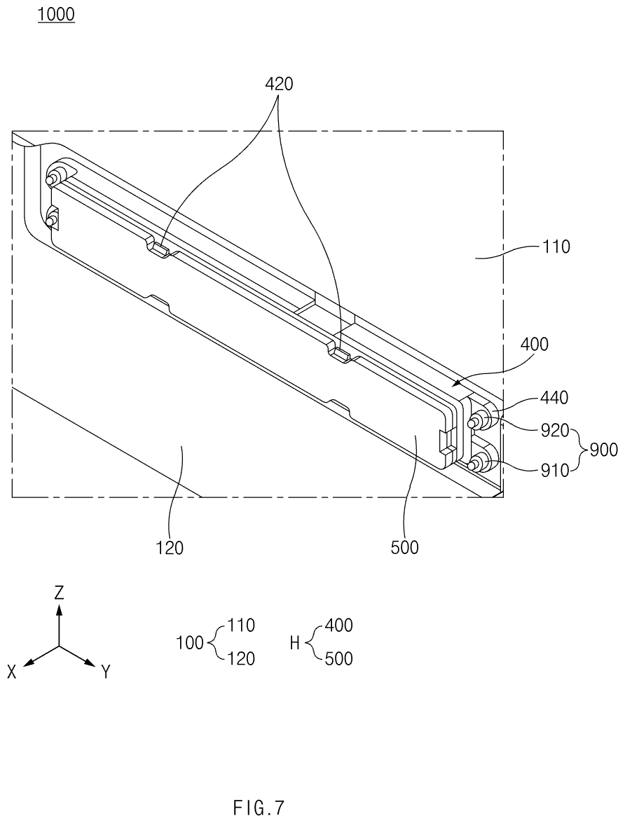

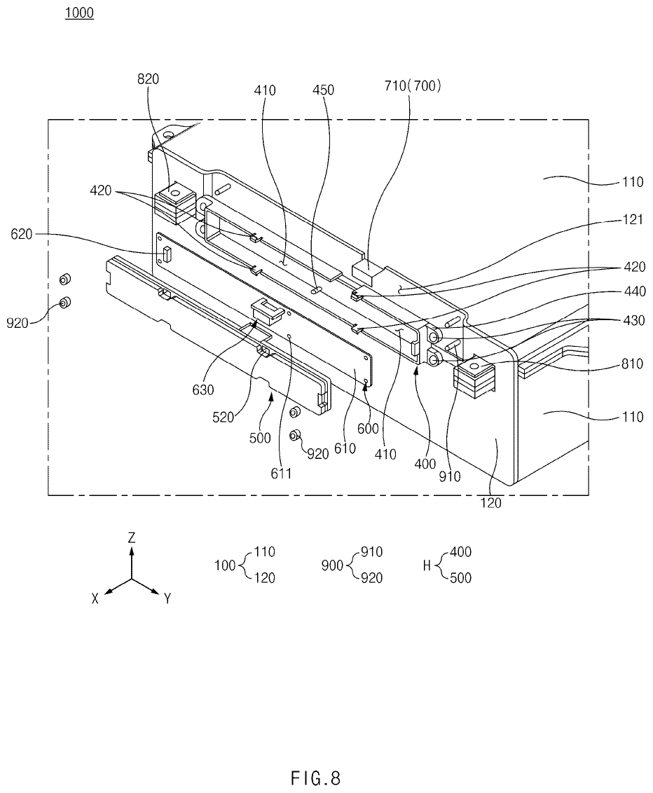

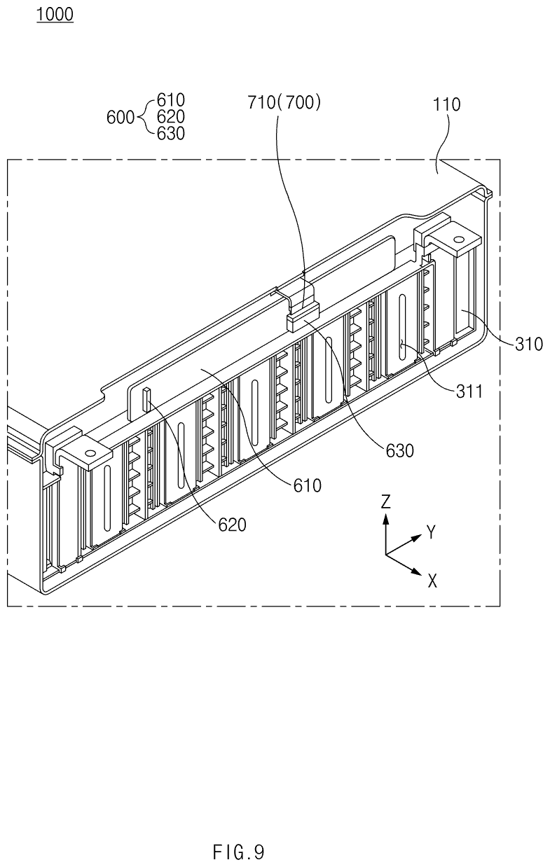

FIG. 7 is a perspective view illustrating a main part of the battery module in the battery pack according to an embodiment of the present invention, FIG. 8 is an exploded perspective view illustrating the main part of the battery module in the battery pack according to an embodiment of the present invention, and FIG. 9 is a perspective view illustrating a concept in which an endplate is removed from the battery module of the battery pack according to an embodiment of the present invention. Here, FIG. 9 illustrates a state in which a state in which the BMS accommodation part is removed from convenience so as to clearly show a state in which the flexible circuit board is connected to the wireless transmission BMS 600.

Referring to FIGS. 3 and 7 to 9, the wireless transmission battery management system (BMS) 600 may receive information of the battery cell 210 from the flexible circuit board 700.

The wireless transmission BMS 600 may include a connection part 630 to which an end 710 of the flexible circuit board 700 is connected.

The wireless transmission BMS 600 may include a wireless transmission part 620 that wirelessly transmits an information signal of the battery cells 210 received from the flexible circuit board 700.

The wireless transmission BMS 600 may include a substrate 610 on which the connection part 630 and the wireless transmission part 620 are mounted. A fitting hole 611 may be defined in the substrate 610.

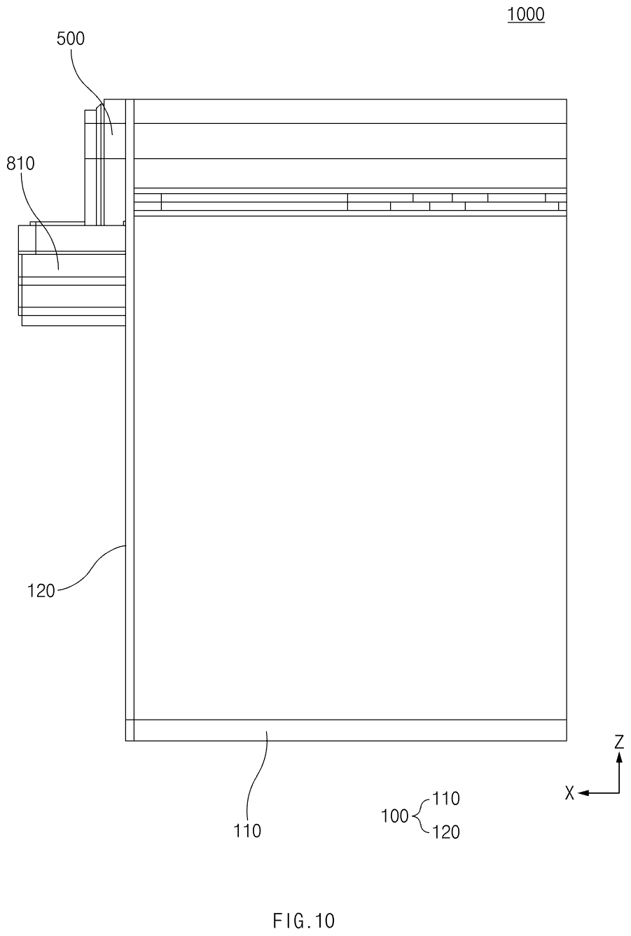

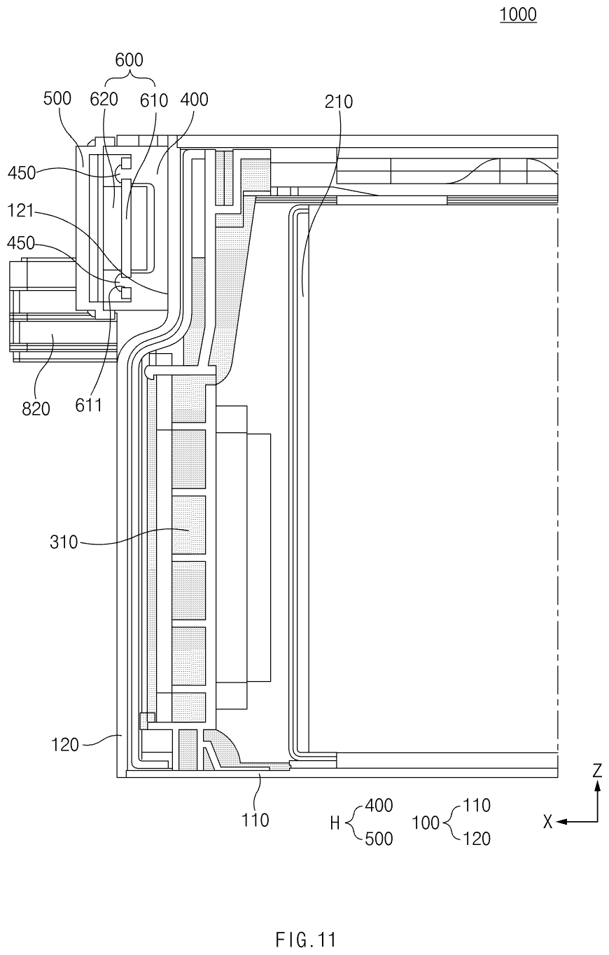

FIG. 10 is a side view illustrating the main part of the battery module in the battery pack according to an embodiment of the present invention, and FIG. 11 is a side view illustrating the main part of the battery module in the battery pack according to an embodiment of the present invention.

Referring to FIGS. 7 to 11, the BMS accommodation part H may be provided outside the module housing 100 so that the wireless transmission BMS 600 is accommodated therein.

Referring to FIGS. 7 and 8, the BMS accommodation part H may include an accommodation case 400 having an accommodation groove 410 that is opened to the outside of the module housing 100 to accommodate the wireless transmission BMS 600. The BMS accommodation part H may further include a cover 500 covering an opening of the accommodation groove 410.

A coupling protrusion 420 may be disposed on the accommodation case 400, and a coupling hole 520 to which the coupling protrusion 420 is coupled may be defined in the cover 500. Thus, as the coupling hole 520 of the cover 500 is coupled to the coupling protrusion 420 of the accommodation case 400, the cover 500 may be detachably coupled to the accommodation case 400. Thus, the wireless transmission BMS 600 accommodated in the accommodation case 400 may be easily replaced.

The accommodation case 400 may be coupled to an outer portion of the module housing 100 through a coupling means 900.

In addition, the accommodation case 400 may have a coupling hole 430 through which the coupling means 900 passes to be coupled. The coupling hole 430 may be defined in the coupling part 440 extending in the Y-axis direction, which is a width direction of the battery module 1000, in the accommodation case 400.

The coupling means 900 may include, for example, a bolt 910 and a nut 920. The bolt 910 may have one side fixed to the module housing 100 and the other side extending to the outside of the module housing 100, and the nut 920 may be coupled to the other side of the bolt 910 after the bolt 910 is coupled to the coupling hole 430 of the accommodation case 400. Here, as the bolt 910 is inserted into the coupling hole 430 of the accommodation case 400, and the nut 920 is coupled to the other side of the bolt 910, the accommodation case 400 may be fixed to an outer portion of the module housing 100. However, in the battery module 1000 of the battery pack according to an embodiment of the present invention, the coupling means 900 may not be necessarily limited to the bolt 910 and the nut 920. For another example, the coupling means 900 may be a rivet or the like.

Referring to FIGS. 8 and 11, the accommodation case 400 may further include a fitting protrusion 450 fitted into the fitting hole 611 of the substrate 610 in the wireless transmission BMS 600. Thus, the wireless transmission BMS 600 may be accommodated in the accommodation case 400 so as not to move.

Referring to FIGS. 2 and 3, the module housing 100 may accommodate the cell stack 200 and the flexible circuit board 700.

The module housing 100 may include a body 110 provided with a stack accommodation part 114, in which the cell stack 200 is accommodated, and having a hollow shape that is opened to both sides, and endplates 120 and 130 covering openings of the body 110. Here, the BMS accommodation part H may be mounted on the endplate 120.

Referring to FIGS. 3, 4 and 3, after the cell stack 200 is accommodated in the stack accommodation part 114 inside the body 110, the surplus space R1 that is an empty space may be defined. Here, the endplate 120 may have a mounting groove 121 that is recessed into the module housing 100 to occupy the surplus space R1. In addition, the BMS accommodation part H may be accommodated in the mounting groove 121 and be mounted on the endplate 120.

The endplates 120 and 130 may be provided in plurality to cover the openings defined at both sides of the body 110, respectively. Here, the BMS accommodation part H may be mounted on one endplate 120 of the plurality of endplates 120 and 130. Here, the plurality of endplates 120 and 130 may be disposed on front and rear surfaces of the body 110, and the BMS accommodation part H may be mounted on the endplate 120 disposed on the front surface of the body 110. In addition, the recessed mounting groove 121 may be defined by pressing the endplate 120 disposed on the front surface of the body 110. In addition, since the endplate 120 disposed on the front surface of the body 110 may be sealed and welded to the body 110, the endplate 120 may have an advantage in terms of sealing and thermal propagation of the module.

The body 110 may include a body 112, which is provided in a “⊂” shape and opened to an upper side, and a top plate covering an upper portion 111 of the body 112. In addition, a gas discharge hole 113 may be defined in the body 110 so that an internal gas is discharged to the outside.

Referring to FIGS. 3, 4, and 9, in the battery pack 1 according to an embodiment of the present invention, the battery module 1000 may further include busbars 310 and 320.

The electrode lead 212 of the battery cell 210 may be electrically connected to the busbars 310 and 320. Here, the electrode lead 212 of the battery cell 210 may pass through the connection hole 311 of the busbars 310 and 320 and be connected to the busbars 310 and 320. The electrode lead 212 may be connected to the busbars 310 and 320 and be electrically connected to terminals 810 and 820.

The busbars 310 and 320 may include an insulating part made of an insulating material and a conductive part made of a material through which electricity is conducted. The conductive part may be a portion connecting a peripheral portion of the connection hole and each of the terminals 810 and 820.

Referring to FIGS. 3, 8 and 9, the flexible circuit board 700 may transfer information of the battery cell 210 to the wireless transmission BMS 600. Here, the flexible circuit board 700 may transfer an information signal of the battery cell 210 to the wireless transmission BMS 600. Here, the information signal of the battery cell 210 may be at least one or more of a remaining capacity, a voltage, and a temperature signal of the battery cell 210.

The flexible circuit board 700 may be, for example, a flexible printed circuit board (FPCB).

In addition, the flexible circuit board 700 may include a measurement sensor, which measures a voltage and current, and be connected to the busbars 310 and 320 to measure the voltage and current flowing inside the busbars 310 and 320. Thus, the electrode lead 212 of the battery cell 210 may be connected to the busbars 310 and 320 to measure the voltage and current flowing inside the busbars 310 and 320, thereby measuring amounts of voltage and current flowing into the battery cell 210.

In addition, the flexible circuit board 700 may include a temperature sensor, and a portion at which the temperature sensor is disposed may be in contact with the cell stack 200 to measure the temperature of the battery cell 210.

In addition, an end 710 of the flexible circuit board 700 may further extend to be connected to the wireless transmission BMS 600.

Referring to FIGS. 1, 3, and 8, a wireless receiving BMS 3000 may wirelessly receive the information signal of the battery cell 210 from the wireless transmitting BMS 600.

The wireless receiving BMS 3000 may determine a state of the battery cell 210 through the received information signal of the battery cell 210 and control charging and discharging of the battery cell 210 so that the battery is maintained in an appropriate state.

The information signal of the battery cell 210 may be at least one of the remaining capacity, the voltage, or the temperature signals of the battery cell 210.

Referring to FIG. 1, the pack case 2000 may accommodate the battery module 1000 therein. Here, the battery module 1000 may be provided in plurality and accommodated inside the pack case 2000.

In addition, the wireless receiving BMS 3000 may be installed inside the pack case 2000 to receive the information signals of the battery cells 210 disposed in each battery module 1000 from the wireless transmission BMS 600 provided in each of the plurality of battery modules 1000.

Referring FIGS. 1 and 8, in the battery pack 1 having the above configuration according to an embodiment of the present invention, the battery module 1000 in the battery pack 1 may include the wireless transmission BMS 600 receiving the information of the battery cell 210 disposed inside the battery module 1000 and the BMS accommodation part, in which the wireless transmission BMS 600 is accommodated, to wirelessly transmit the information of the battery cell 210. Thus, the low voltage (LV) connecting the battery management system BMS inside the battery pack may not be used to reduce the occurrence of the safety risk. That is, the bundle of the wires such as the LV connecting the BMS may be removed to prevent the risk of the short circuit caused by applying the current and voltage to the bundle of the wires such as the LV.

In addition, the BMS accommodation part H may be coupled to the outside of the module housing 100 by means of coupling means to facilitate modularization, and when the wireless transmission BMS 600 accommodated in the BMS accommodation part H is broken, the accessibility and repair may be easy, and peripheral steel parts that interfere with communication of the wireless transmission BMS 600 may be minimized.

In addition, the BMS accommodation part H may be mounted on the endplate 120 of the module housing 100 and also may be mounted in the mounting groove 121 recessed from the endplate 120 toward the internal surplus space R1 of the module housing 100 to minimize a space wasted in the form of a terrace of the battery cell 210 defining the surplus space R1 inside the battery module 1000.

While the present invention has been particularly shown and described with reference to exemplary embodiments thereof, it is to be understood that the scope of the present invention is not limited thereto. It will be understood by those of ordinary skill in the art that various changes in form and details may be made therein without departing from the spirit and scope of the present invention.

Furthermore, the scope of protection of the present invention will be clarified by the appended claims.

### DESCRIPTION OF THE SYMBOLS

1: Battery pack
1000: Battery module
2000: Pack case
3000: Wireless receiving BMS
100: Module housing
110: Body
111: Upper plate
112: Body
113: Gas discharge hole
120,130: Endplate
121: Mounting groove
200; Cell stack
210: Battery cell
211: Pouch
212: Electrode lead
310,320: Busbar
311: Connection hole
400: Accommodation case
410: Accommodation groove
420: Coupling protrusion
430: Coupling hole
440: Coupling part
450: Fitting protrusion
500: Cover
520: Coupling hole
600: Wireless transmission BMS
610: Substrate
611: Fitting hole
620; Wireless transmission part
630: Connection part
700: Flexible circuit board
710: End
810, 820: Terminal
900: Coupling means
910; Bolt
920: Nut
H: BMS accommodation part
R: Upper edge portion
R1: Surplus space

1. A battery pack comprising:
a battery module, wherein the battery module comprises:
a cell stack in which a plurality of battery cells are stacked;
a flexible circuit board configured to transmit information at least one battery cell of the plurality of battery cells;
a module housing configured to accommodate the cell stack and the flexible circuit board;
a wireless transmission battery management system (BMS) configured to receive the information of the at least one battery cell from the flexible circuit board; and
a BMS accommodation part provided outside the module housing to accommodate the wireless transmission BMS.

2. The battery pack of claim 1, wherein the BMS accommodation part comprises an accommodation case having an accommodation groove that is opened to the outside of the module housing to accommodate the wireless transmission BMS.

3. The battery pack of claim 2, wherein the accommodation case is coupled to an outer portion of the module housing through a coupler.

4. The battery pack of claim 3, wherein the accommodation case has a coupling hole through which the coupler passes to be coupled.

5. The battery pack of claim 2, wherein the BMS accommodation part further comprises a cover configured to cover an opening of the accommodation groove.

6. The battery pack of claim 5, wherein a coupling protrusion is disposed on the accommodation case, and
wherein the cover has a coupling hole to which the coupling protrusion is coupled.

7. The battery pack of claim 1, wherein the module housing comprises:
a hollow body having a stack accommodation part, in which the cell stack is accommodated therein and is opened to both sides; and
an endplate configured to cover an opening of the hollow body, and
wherein the BMS accommodation part is mounted on the endplate.

8. The battery pack of claim 7, wherein a surplus space that is an empty is defined inside the hollow body after the cell stack is accommodated in the stack accommodation part,
wherein the endplate has a mounting groove recessed to an inside of the module housing to occupy the surplus space, and
wherein the BMS accommodation part is accommodated in the mounting groove and mounted on the endplate.

9. The battery pack of claim 1, wherein the wireless transmission BMS comprises a connection part to which an end of the flexible circuit board is connected.

10. The battery pack of claim 1, wherein the wireless transmission BMS comprises a wireless transmission part configured to transmit an information signal of the at least one battery cell, and which is received from the flexible circuit board.

11. The battery pack of claim 1, wherein the battery pack further comprises a wireless receiving BMS configured to wirelessly receive an information signal of the at least one battery cell from the wireless transmission BMS.

12. The battery pack of claim 11, wherein the wireless receiving BMS is configured to determine a state of the at least one battery cell through the received information signal of the at least one battery cell and control at least one of a charging and a discharging of the at least one battery cell so that the at least one battery cell is maintained in a predetermined state.

13. The battery pack of claim 12, wherein the information signal of the at least one battery cell comprises at least one of a remaining capacity, a voltage and a temperature signal of the at least one battery cell.

14. The battery pack of claim 11, wherein the battery module is provided in plurality,
wherein the battery pack further comprises a pack case configured to accommodate the plurality of battery modules therein, and
wherein the wireless receiving BMS is installed inside the pack case to receive an information signal of a battery cell disposed in each battery module from a wireless transmission BMS provided in each of the plurality of battery modules.
